(19) United States
(12) Patent Application Publication
(10) Pub. No.: US 2026/0067112 A1
(43) Pub. Date: Mar. 5, 2026

(54) TECHNOLOGIES FOR AUTOMATED SCHEDULING OF MEETINGS

(71) Applicant: BVS Holdings, LLC, Boston, MA (US)

(72) Inventors: Paul English, Boston, MA (US); Sam Cohen, Aventura, FL (US); Rachel Cohen, Boston, MA (US); Swagata Chakrabarti, Boston, MA (US)

(21) Appl. No.: 18/822,636

(22) Filed: Sep. 3, 2024

(51) Int. Cl. H04L 12/18

(52) U.S. Cl. CPC H04L 12/1818; H04L 12/1822

(57) ABSTRACT

Technologies for automated scheduling of meetings includes a server computer and a set of user computer devices. The server computer may be configured to analyze an email communication received by the server computer and from a sender (i.e., a user of one of the user computer devices) to determine a set of participants for a meeting and a set of meeting parameters of the meeting. The set of participants includes a host identified as the sender of the email communication and at least one invitee. The set of meeting parameters defines characteristics of the meeting. The server computer may also analyze a digital calendar of each participant to identify a time slot (e.g., a day and time) that satisfies the set of meeting parameters and schedule the meeting on the digital calendar of each participant of the set of participants at the identified time slot.

### FIELD OF THE DISCLOSURE

The present disclosure relates generally to technologies for scheduling a meeting and, more particularly, to technologies for automated scheduling of digital meetings based on electronic mail (“email”) communications.

### BACKGROUND

Due to the ever increasing mobility of individuals, the facilitation of remote work, increased travel, complex schedules, and other factors, the scheduling of meetings for both personal and business purposes has vastly increased in importance. For personal use, scheduled meetings provide a reminder of a commitment to connect, attend an event, or engage in other social activities. For business use, scheduled meetings provide a defined time for team members to discuss matters of business. In particular, the recent increased use of digital or virtual meetings allow participants who may be physically or geographically separated from each other to attend the meeting.

However, scheduling a meeting can be difficult for a variety of reasons. For example, as the number of participants of the meeting grows, the difficulty in identifying a common meeting day and time that is acceptable to all participants increases. Additionally, it can be difficult to determine who should be invited to a particular meeting. Furthermore, determining the acceptable length of the meeting can be challenging, especially when the meeting length causes scheduling conflicts between participants. Typically, the scheduling details of a proposed meeting are determined via multiple back-and-forth email correspondences, phone calls, and/or other forms of contact between the participants, which can be time intensive and ultimately delay the scheduling of the meeting. Furthermore, in situations in which rescheduling of a meeting is required, such rescheduling typically occurs ad hoc and can be an onerous, iterative task that adds additional time and complexity. While the scheduling and rescheduling of meetings is transactional in nature, those activities are often necessary prerequisites to the finalization of a meeting.

### SUMMARY

According to an aspect of the present disclosure, a method for automated scheduling of a meeting may include receiving, by a server computer, an email communication from a sender and determining, by the server computer, whether to schedule the meeting based on whether the email communication includes an indicator that indicates a desire by the sender to schedule the meeting. The method may also include analyzing, by the server computer and in response to a determination to schedule the meeting, the email communication to determine a set of participants for the meeting. The set of participants may include a host identified as the sender of the email communication and at least one invitee. The method may further include analyzing, by the server computer and in response to the determination to schedule the meeting, the email communication to determine a set of meeting parameters. The set of meeting parameters may define characteristics of the meeting. The method may also include analyzing, by the server computer, a digital calendar of each participant of the set of participants to identify a time slot that satisfies the set of meeting parameters and scheduling, by the server computer, the meeting on the digital calendar of each participant of the set of participants at the identified time slot.

In some embodiments, determining whether to schedule the meeting may include determining whether a reference email address is included in the email communication. Additionally, in some embodiments, analyzing the email communication to determine a set of participants for the meeting may include determining each recipient of the email communication. Additionally or alternatively, in some embodiments, analyzing the email communication to determine a set of participants for the meeting may include analyzing the email to determine a participant of the meeting that is (i) mentioned in the email communication and (ii) not a recipient of the email communication.

Additionally, in some embodiments, analyzing the email communication to determine the set of meeting parameters may include setting each meeting parameter of the set of meeting parameters to a default parameter. Additionally or alternatively, analyzing the email communication to determine the set of meeting parameters may include analyzing the email communication to determine a meeting subject, a meeting duration, a meeting date, or a meeting time for the meeting.

In some embodiments, analyzing the email communication to determine the set of meeting parameters may include determining at least one meeting parameter of the set of meeting parameters based on a user-defined preference of a participant of the set of participants of the meeting. Additionally or alternatively, analyzing the email communication to determine the set of meeting parameters may include determining at least one meeting parameter of the set of meeting parameters based on a user history of a participant of the set of participants of the meeting.

Additionally, in some embodiments, analyzing the digital calendar of each participant of the set of participants to identify the time slot that satisfies the set of meeting parameters include identifying, by the server computer, a conflicting meeting of at least one participant of the set of participants that conflicts with the identified time slot; determining, by the server computer, whether the conflicting meeting can be rescheduled; and adjusting, by the server computer, the conflicting meeting on the digital calendar of the at least one participant to a different time slot than the identified time slot. In such embodiments, determining whether the conflicting meeting can be rescheduled may include determining whether the conflicting meeting can be rescheduled based on a characteristic of the conflicting meeting. For example, the characteristic of the conflicting meeting may include at least one of a subject matter of the conflicting meeting, a number of participants of the conflicting meeting, and a location of the conflicting meeting. Additionally or alternatively, determining whether the conflicting meeting can be rescheduled may include determining whether the conflicting meeting can be rescheduled based on a characteristic of the least one participant of the set of participants. For example, the characteristic of the least one participant of the set of participants may include a user preference, a user history, or a user priority of the least one participant of the set of participants.

According to another aspect of the present disclosure, a server computer for automated scheduling of a meeting may include a processor and a memory having stored therein a plurality of instructions that, when executed by the processor, cause the server computer to determine whether to schedule the meeting based on whether an email communication received by the server computer and from a sender includes an indicator that indicates a desire by the sender to schedule the meeting. The plurality of instructions may further cause the server computer to analyze, in response to a determination to schedule the meeting, the email communication to determine a set of participants for the meeting. The set of participants may include a host identified as the sender of the email communication and at least one invitee. The plurality of instructions may also cause the server computer to analyze, in response to the determination to schedule the meeting, the email communication to determine a set of meeting parameters. The set of meeting parameters may define characteristics of the meeting. Additionally, the plurality of instructions may cause the server computer to analyze a digital calendar of each participant of the set of participants to identify a time slot that satisfies the set of meeting parameters and schedule the meeting on the digital calendar of each participant of the set of participants at the identified time slot.

In some embodiments, to analyze the digital calendar of each participant of the set of participants to identify the time slot that satisfies the set of meeting parameters comprises to identify a conflicting meeting of at least one participant of the set of participants that conflicts with the identified time slot, determine whether the conflicting meeting can be rescheduled, and adjust the conflicting meeting on the digital calendar of the at least one participant to a different time slot than the identified time slot. For example, to determine whether the conflicting meeting can be rescheduled may include to determine whether the conflicting meeting can be rescheduled based on a characteristic of the conflicting meeting or on a characteristic of the least one participant of the set of participants.

According to yet a further aspect of the present disclosure, one or more non-transitory, computer-readable storage media comprising a plurality of instructions that, in response to execution, cause a server computer to determine whether to schedule the meeting based on whether an email communication received by the server computer and from a sender includes an indicator that indicates a desire by the sender to schedule the meeting. The plurality of instructions may further cause the server computer to analyze, in response to a determination to schedule the meeting, the email communication to determine a set of participants for the meeting. The set of participants may include a host identified as the sender of the email communication and at least one invitee. The plurality of instructions may also cause the server computer to analyze, in response to the determination to schedule the meeting, the email communication to determine a set of meeting parameters. The set of meeting parameters may define characteristics of the meeting. Additionally, the plurality of instructions may cause the server computer to analyze a digital calendar of each participant of the set of participants to identify a time slot that satisfies the set of meeting parameters and schedule the meeting on the digital calendar of each participant of the set of participants at the identified time slot.

In some embodiments, to analyze the digital calendar of each participant of the set of participants to identify the time slot that satisfies the set of meeting parameters comprises to identify a conflicting meeting of at least one participant of the set of participants that conflicts with the identified time slot, determine whether the conflicting meeting can be rescheduled, and adjust the conflicting meeting on the digital calendar of the at least one participant to a different time slot than the identified time slot. For example, to determine whether the conflicting meeting can be rescheduled may include to determine whether the conflicting meeting can be rescheduled based on a characteristic of the conflicting meeting or on a characteristic of the least one participant of the set of participants.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for automated scheduling of meetings;

FIG. 2 is a simplified block diagram of an environment that may be established by a calendar scheduling server of the system of FIG. 1;

FIG. 3 is a simplified block diagram of an environment that may be established by a user computer device of the system of FIG. 1;

FIGS. 4A and 4B are a simplified flow diagram of at least one embodiment of a method for automated scheduling of a meeting that may be executed by the calendar scheduling server of FIGS. 1 and 2;

FIG. 5 is a simplified flow diagram of at least one embodiment of a method for determining meeting participants that may be executed by the calendar scheduling server of FIGS. 1 and 2 as a portion of the method of FIG. 4;

FIG. 6 is a simplified flow diagram of at least one embodiment of a method for determining meeting parameters that may be executed by the calendar scheduling server of FIGS. 1 and 2 as a portion of the method of FIG. 4;

FIGS. 7A-7C are a simplified flow diagram of at least one embodiment of a method for determining an available meeting time slot for each meeting participant that satisfies the meeting parameters, which may executed by the calendar scheduling server of FIGS. 1 and 2 as a portion of the method of FIG. 4;

FIG. 8 is a simplified flow diagram of at least one embodiment of a process flow of a transmission of an email communication from a user computer device of the system of FIG. 1 to the calendar scheduling server of the system of FIG. 1 through several intervening servers of the network of the system of FIG. 1;

FIG. 9 is an illustrative table of estimated best and worst times for completion of processes of the process flow of FIG. 8;

FIG. 10 is a simplified flow diagram of at least one embodiment of a process flow of a transmission of an email communication from a user computer device of the system of FIG. 1 to the calendar scheduling server of the system of FIG. 1 in an embodiment in which the calendar scheduling server is embodied as a dedicated server;

FIG. 11 is a simplified flow diagram of at least one embodiment of a process flow of a transmission of an email communication from a user computer device of the system of FIG. 1 to the calendar scheduling server of the system of FIG. 1 in an embodiment in which the calendar scheduling server is embodied as a server dedicated to a single enterprise;

FIG. 12 is an illustration of a user interface that may be displayed on a user computer device of the system of FIG. 1 during the execution of the method of FIG. 4 by the calendar scheduling server of FIGS. 1 and 2;

FIG. 13 is an illustration of another user interface that may be displayed on a user computer device of the system of FIG. 1 during the execution of the method of FIG. 4 by the calendar scheduling server of FIGS. 1 and 2;

FIG. 14 is an illustration of another user interface that may be displayed on a user computer device of the system of FIG. 1 during the execution of the method of FIG. 4 by the calendar scheduling server of FIGS. 1 and 2; and

FIG. 15 is an illustration of another user interface that may be displayed on a user computer device of the system of FIG. 1 during the execution of the method of FIG. 4 by the calendar scheduling server of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

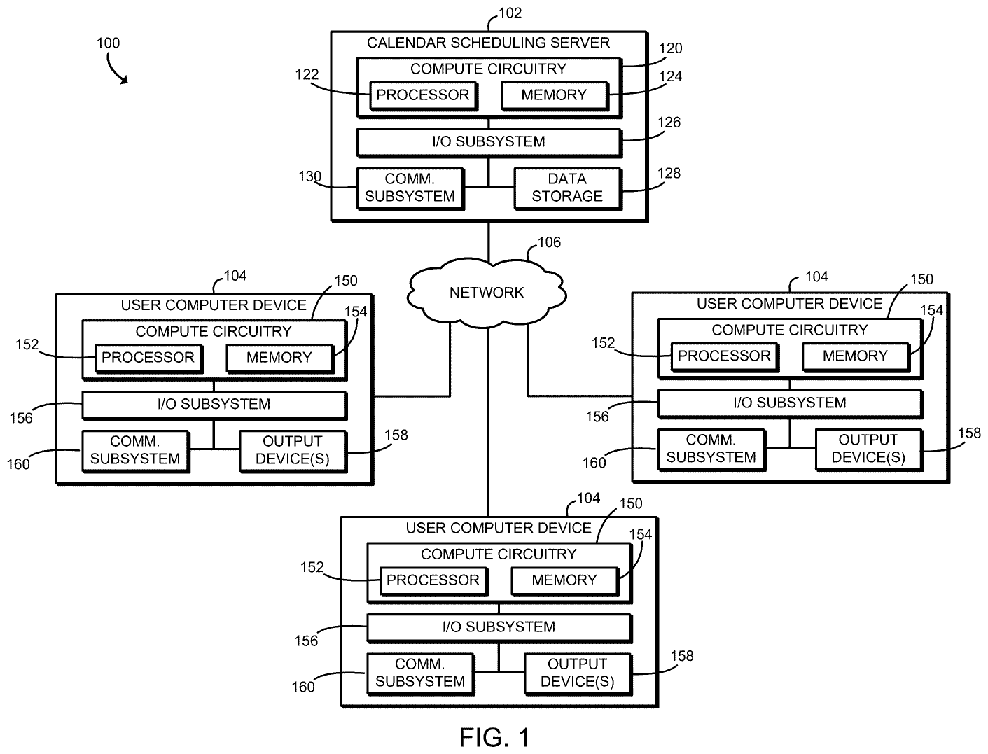

Referring now to FIG. 1, an illustrative system 100 for automated scheduling of meetings includes a calendar scheduling server 102 and a set of user computer devices 104, which are configured to communicate with the calendar scheduling server 102 over a network 106. In use, as discussed in more detail below, a user of one of the user computer devices 104 (i.e., the “host”) may request the automated scheduling of a meeting with the users of other user computer devices 104 (i.e., the “invitees”) by including an email address managed by the calendar scheduling server 102, or other indicator, on an email communication to those other users. In response to receiving the email communication, the calendar scheduling server 102 is configured to schedule a meeting between each user of the user computer devices 104, including the sender of the email communication, in an automated fashion.

To do so, the calendar scheduling server 102 analyzes the email communication to determine the set of participants that should be included in the meeting, which includes the original sender of the email communication as the host and the other users of the user computer devices 104 as the invitees of the to-be-scheduled meeting. As discussed in more detail below, the calendar scheduling server 102 may determine the set of participants by analyzing the sender and other recipients of the email communication, by identifying participants referenced in the body of the email commutation (e.g., throughout the email communication), and/or by inferring participants of the meeting based on the content of the email communication, user preferences, user history, and/or other considerations.

The calendar scheduling server 102 is also configured to analyze the email communication to determine a set of meeting parameters that the to-be-scheduled meeting should satisfy (e.g., meeting duration, meeting day, meeting time, etc.). The calendar scheduling server 102 may determine the meeting parameters based on any suitable data or analysis techniques such a set of default meeting parameters or based on an analysis of the content of the email communication itself. For example, the calendar scheduling server 102 may determine the subject of the meeting, a duration of the meeting, and/or an acceptable day and time (i.e., “a time slot”) or range of days/times for the proposed meeting based on the content of the email communication itself. Additionally, in some embodiments, the calendar scheduling server 102 may be configured to determine or adjust the meeting parameters based on user-defined preferences of each participant (e.g., a particular participant may block-out a particular day from all meetings) and/or a user history of each participant (e.g., whether a participant takes lunch at a particular time each day). Of course, the global set of user-defined preferences and/or user histories of the participants may cause conflicts in the scheduling or otherwise be incompatible with each other. In such situations, the calendar scheduling server 102 may be configured to adjust the meeting parameters based on additional criteria, such as a user hierarchy assigned to each participant. For example, a user-defined preference of a participant having a higher user hierarchy (e.g., a team lead) may be weighted higher or satisfied at a higher degree than the user-defined preference of a participant having a lower user hierarchy (e.g., a team member). Of course, the user hierarchy assigned to each participant may be relative to each other such that a particular participant may have different user hierarchies depending on which other participant that particular participant is being compared to. For example, a middle management participant may have a high user hierarchy relative to a new employee but have a low user hierarchy relative to a company executive.

After the calendar scheduling server 102 has determined the meeting participants and meeting parameters, the calendar scheduling server 102 analyzes the digital calendars of each participant to determine a time slot (i.e., a day, time, and duration) on each digital calendar that satisfies the identified meeting parameters. If the calendar scheduling server 102 does not presently have access to the digital calendar of a particular participant, the calendar scheduling server 102 may send an email correspondence to that participant requesting that they link (i.e., provide access to) their digital calendar to the calendar scheduling server 102 or may offer the user to manage their digital calendar directly on the calendar scheduling server 102. After the calendar scheduling server 102 has identified an available time slot on each participant's digital calendar that satisfies the meeting parameters, the calendar scheduling server 102 sends an invite for a meeting at that identified time slot to each participant so as to automatically schedule the meeting without further effort and/or communication on part of the participants.

Of course, depending on various factors such as the total number of participants, the time of year, and the present number of other scheduled activities, the calendar scheduling server 102 may be unable to identify an available time slot on each participant's digital calendar that satisfies the meeting parameters. For example, one or more participants may have an existing, conflicting meeting that restricts the ability of the calendar scheduling server 102 to schedule the requested meeting such that the requested meeting satisfies the meeting parameters (e.g., within an acceptable time span from the present date). In such situations, the calendar scheduling server 102 may be configured to determine whether a conflicting meeting on one or more participant's digital calendar can be adjusted. For example, the calendar scheduling server 102 may determine whether the conflicting meeting can be rescheduled or overbooked (i.e., whether the new meeting can be scheduled at the same time as the existing, conflicting meeting). To do so, the calendar scheduling server 102 may determine characteristics of the conflicting meeting (e.g., the subject matter of conflicting meeting, the participant size of the conflicting meeting, the location of the conflicting meeting, etc.) and/or characteristics of the participant having the conflicting meeting (e.g., user-defined preferences, user history, user hierarchy, etc.), each of which may be considered by the calendar scheduling server 102 in determining whether a particular conflicting meeting can be rescheduled/overbooked. If the calendar scheduling server 102 determines that the conflicting meeting can be rescheduled or overbooked, the calendar scheduling server 102 attempts to adjust the conflicting meeting accordingly. That is, the calendar scheduling server 102 may “automatically” rescheduled the conflicting meeting by moving it to an available time slot on that participant's digital calendar or overbook the conflicting meeting by scheduling the new meeting over that conflicting meeting. In either case, the calendar scheduling server 102 may communicate with the affected participant to obtain their approval and/or inform them of the adjustment. In this way, the calendar scheduling server 102 is configured to provide an automated scheduling solution to users of the system 100 that is capable of identifying time slots on digital calendars of identified participants by rescheduling or overbooking existing, conflicting meetings as needed.

The calendar scheduling server 102 may be embodied as any type of computation or computer device capable of performing the functions described herein, including, without limitation, a server, a rack-mounted server, a blade server, a workstation, a network appliance, a web appliance, a desktop computer, a laptop computer, a tablet computer, a smartphone, a consumer electronic device, a distributed computing system, and/or a multiprocessor system. Additionally, in some embodiments, the calendar scheduling server 102 may be embodied as a “virtual server” formed from multiple computing devices distributed across the network 106 and operating in a public or private cloud. Accordingly, although the calendar scheduling server 102 is illustrated in FIG. 1 as embodied as a single computing device, it should be appreciated that the calendar scheduling server 102 may be embodied as multiple devices cooperating together to facilitate the functionality described below.

As shown in FIG. 1, the illustrative calendar scheduling server 102 includes compute circuitry 120, an I/O subsystem 126, a data storage device 128, and a communication subsystem 130. Of course, the calendar scheduling server 102 may include other or additional components, such as those commonly found in a typical server or other computer (e.g., various input/output devices), in other embodiments. Additionally, in some embodiments, one or more of the illustrative components may be incorporated in, or otherwise form a portion of, another component.

The compute circuitry 120 may be embodied as any type of device or collection of devices capable of performing various compute functions. In some embodiments, the compute circuitry 120 may be embodied as a single device such as an integrated circuit, an embedded system, a field-programmable-array (FPGA), a system-on-a-chip (SOC), or other integrated system or device. Additionally, in some embodiments, the compute circuitry 120 includes or is embodied as a processor 122 and memory 124. The processor 122 may be embodied as any type of processor capable of performing the functions described herein. For example, the processor 122 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the calendar scheduling server 102 such as operating systems, applications, programs, libraries, and drivers.

The compute circuitry 120 is communicatively coupled to other components of the calendar scheduling server 102 via the I/O subsystem 126, which may be embodied as circuitry and/or components to facilitate input/output operations with compute circuitry 120 (e.g., with the processor 122 and/or memory 124) and other components of the calendar scheduling server 102. For example, the I/O subsystem 126 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 126 may be incorporated, along with the processor 122, the memory 124, and other components of the calendar scheduling server 102, into the compute circuitry 120.

The data storage device 128 may be embodied as any type of device or devices configured for short-term or long-term storage of data such as, for example, memory devices and circuits, memory cards, hard disk drives, solid-state drives, or other data storage devices. The communication subsystem 130 of the calendar scheduling server 102 may be embodied as any communication circuit, device, or collection thereof, capable of enabling communications between the calendar scheduling server 102 and the user computer devices 104 over the network 106. The communication subsystem 130 may be configured to use any one or more communication technology (e.g., wireless or wired communications) and associated protocols (e.g., Ethernet, Bluetooth®, Bluetooth Low Energy (BLE), Wi-Fi®, WiMAX, 3G LTE, 5G, etc.) to effect such communication.

Each user computer device 104 may be embodied as any type of computer device capable of performing the functions described herein. For example, the user computer device 104 may be embodied as, without limitation, a smartphone, a mobile computing device, a computer, a laptop computer, a notebook computer, a tablet computer, a wearable computing device, a processor-based system, and/or a consumer electronic device. In the illustrative embodiment, each user computer device 104 is embodied as a personal computer device on which the respective user may maintain a personal digital calendar, in some embodiments. The personal digital calendar may be stored locally on the user computer device 104 or on another computer device (e.g., the calendar scheduling server 102 or a third-party server) of the system 100.

As shown in FIG. 1 and similar to the calendar scheduling server 102, each user computer device 104 includes compute circuitry 150, an I/O subsystem 156, an output device 158, and a communication subsystem 160. Of course, each user computer device 104 may include other or additional components, such as those commonly found in a mobile computer device (e.g., short and/or long term data storage), in other embodiments. Additionally, in some embodiments, one or more of the illustrative components may be incorporated in, or otherwise form a portion of, another component.

The compute circuitry 150 may be embodied as any type of device or collection of devices capable of performing various compute functions. In some embodiments, the compute circuitry 150 may be embodied as a single device such as an integrated circuit, an embedded system, a field-programmable-array (FPGA), a system-on-a-chip (SOC), or other integrated system or device. Additionally, in some embodiments, the compute circuitry 150 includes or is embodied as a processor 152 and memory 154. The processor 152 may be embodied as any type of processor capable of performing the functions described herein. For example, the processor 152 may be embodied as a single or multi-core processor(s), digital signal processor, microcontroller, or other processor or processing/controlling circuit. Similarly, the memory 154 may be embodied as any type of volatile or non-volatile memory or data storage capable of performing the functions described herein. In operation, the memory 154 may store various data and software used during operation of the respective user computer device 104 such as operating systems, applications, programs, libraries, and drivers.

The compute circuitry 150 is communicatively coupled to other components of the respective user computer device 104 via the I/O subsystem 156, which may be embodied as circuitry and/or components to facilitate input/output operations with compute circuitry 150 (e.g., with the processor 152 and/or memory 154) and other components of the respective user computer device 104. For example, the I/O subsystem 156 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 156 may be incorporated, along with the processor 152, the memory 154, and other components of the respective user computer device 104, into the compute circuitry 150.

The output device(s) 158 may be embodied as any type of output device capable of presenting an output or information to the user of the respective user computer device 104. For example, in the illustrative embodiment, the output device 158 is embodied as be embodied as, or otherwise include, a visual output device such as a display screen.

The communication subsystem 160 of the respective user computer device 104 may be embodied as any communication circuit, device, or collection thereof, capable of enabling communications between the respective user computer device 104, the calendar scheduling server 102, and/or other computer devices of the system 100. The communication subsystem 160 may be configured to use any one or more communication technology (e.g., wireless or wired communications) and associated protocols (e.g., Ethernet, Bluetooth®, Bluetooth Low Energy (BLE), Wi-Fi®, WiMAX, 3G LTE, 5G, etc.) to effect such communication.

As discussed in more detail below, the calendar scheduling server 102 is configured to communicate with each of the user computer devices and/or other devices of the system 100 over the network 106. The network 106 may be embodied as any number of various wired and/or wireless networks. For example, the network 106 may be embodied as, or otherwise include, a wired or wireless local area network (LAN), a wired or wireless wide area network (WAN), a cellular network, and/or a publicly-accessible, global network such as the Internet. As such, the network 106 may include any number of additional devices, such as additional computers, routers, stations, and switches, to facilitate communications among the devices of the system 100.

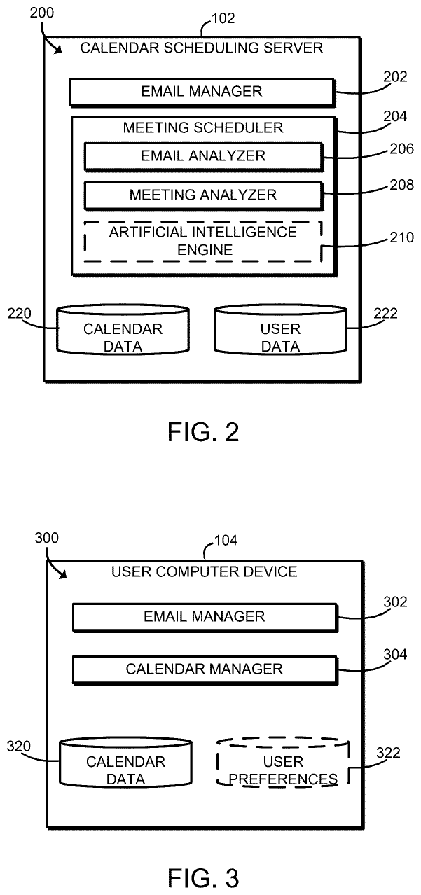

Referring now to FIG. 2, in the illustrative embodiment, the calendar scheduling server 102 is configured to establish an environment 200 during operation. The illustrative environment 200 includes an email manager 202, a meeting scheduler 204, and various data sets including, for example, calendar data 220 and user data 222. The various components of the environment 200 may be embodied as hardware, firmware, software, or a combination thereof. As such, in some embodiments, one or more of the components of the environment 200 may be embodied as circuitry or a collection of electrical devices (e.g., email manager circuitry 202, meeting scheduler circuitry 204, etc.) It should be appreciated that, in such embodiments, one or more of those components may form a portion of the processor 122, the I/O subsystem 126, and/or other components of the calendar scheduling server 102.

The email manager 202 is configured to manage the email communications received from and sent to the user computer devices 104. That is, the email manager 202 receives the initial email from the “host” user, which includes an indicator that indicates a desire by the sender to schedule the meeting. For example, in the illustrative embodiment, the indicator may be embodied as the inclusion of a particular email address monitored or otherwise managed by the calendar scheduling server 102 in the recipient list of the email (e.g., as a carbon copied recipient). In other embodiments, the indicator may be embodied as a key phrase or code, which may be included in the subject line or the content of the email. If the email manager 202 detects the indicator in the received email, the email manager 202 is configured to pass that email along to the meeting scheduler 204 for analysis. The email manager 202 also manages outgoing email from the calendar scheduling server 102 to, for example, schedule the determined meeting, confirm the availability of a participant, and/or otherwise communicate with the user computer devices 104.

The meeting scheduler 204 is configured to analyze the received email including the indicator that indicates a desire by the sender to schedule a meeting and schedule the meeting with the desired participants. To do so, the meeting scheduler 204 includes an email analyzer 206 configured to analyze the received email to determine the set of participants that should be included in the meeting and a set of meeting parameters. The email analyzer 206 may determine the set of participants using any suitable methodology. For example, in some embodiments, the email analyzer 206 may analyze the email to determine the sender and other recipients of the email communication, analyze the body of the email to identify participants referenced in the email, and/or by infer the participants of the meeting based on the content of the email communication, user preferences, user history, and/or other considerations.

The email analyzer 206 is also configured to analyze the received email to determine a set of meeting parameters that the requested meeting should satisfy. As discussed above, the meeting parameters define characteristics (e.g., meeting subject, meeting duration, meeting day and time, etc.) that should be embodied by the scheduled meeting. The email analyzer 206 may determine the meeting parameters using any suitable methodology and associated data. For example, in some embodiments, the email analyzer 206 may determine the meeting parameters based on a pre-defined set of default meeting parameters, which may be universally- or user-defined. Additionally or alternatively, the email analyzer 206 may determine the meeting parameters based on the content of the email communication received from the “host.” For example, the email analyzer 206 may analyze conversations included the body of the email to determine or infer the meeting parameters. Furthermore, in some embodiments, the email analyzer 206 may determine or adjust the meeting parameters based on user-defined preferences of each participant and/or upon a user history associated with each participant, which may be stored in the user data 222. For example, a participant may establish a user-defined preference not to have meeting before and/or after a certain time of the day, to limit the meeting duration to maximum length, to be included or not included on meetings based on the subject matter of the meeting, etc. Additionally or alternatively, the user history may indicate a preference for early or late meetings, meetings on or not on a certain day, and or meetings spaced from each other by a particular amount of time. As mentioned above, the user-defined preferences and/or user histories of the participants of the meeting may be incompatible with each other and, in such cases, the email analyzer 206 may be configured to weigh each user-defined preference and/or user history based on a user hierarchy assigned to that particular user. That is, the email analyzer 206 may attempt to satisfy or match the user preferences and/or user histories of participants having a higher user hierarchy before attempting to satisfy or match the user preferences and/or user histories of participants having a lower user hierarchy. Again, as discussed above, the user hierarchies may be relative to each other, and any single participant may have multiple user hierarchy scores based on the participant to whom that particular participant is being compared. The user hierarchies may be assigned globally or by each participant. Additionally, in some embodiments, the calendar scheduling server 102 may be configured to infer or learn user hierarchies over time by, for example, analyzing email communications between users, analyzing company rosters, and/or other suitable methodologies.

The meeting scheduler 204 also includes a meeting analyzer 208 configured to analyze the digital calendars of each participant to determine a time slot available on each participant's calendar that satisfies the identified meeting parameters. In some embodiments, the digital calendar of each participant is stored and managed locally on the calendar scheduling server 102 in the calendar data 220. In other embodiments, the digital calendar of each participant may be linked to the calendar scheduling server 102 and accessible by the meeting analyzer 208. After the meeting analyzer 208 identifies an available time slot of each participant's digital calendar, the email manager 202 generates a meeting invite that is sent to each identified participant for a meeting at the identified time slot.

However, as discussed above, the meeting analyzer 208 may encounter a conflicting meeting on a digital calendar of one or more participants that limits the ability of the meeting analyzer 208 to schedule a meeting that satisfies the meeting parameters. In such circumstances the meeting analyzer 208 is configured to determine whether the conflicting meeting can be adjusted. For example, the meeting analyzer 208 may determine whether the conflicting meeting can be rescheduled or overbooked. To do so, as discussed above, the meeting analyzer 208 may consider characteristics of the conflicting meeting and/or or characteristics of the participant having the conflicting meeting to determine whether the conflicting meeting can be rescheduled/overbooked. If the meeting analyzer 208 determines that the conflicting meeting can be rescheduled or overbooked, the meeting analyzer 208 attempts to adjust the conflicting meeting accordingly by automatically rescheduling the conflicting meeting or scheduling the new meeting over the conflicting meeting. To do so, the meeting analyzer 208 may interface with the email manager 202 to request authorization to reschedule and/or overbook the conflicting meeting from the respective participant.

In some embodiments, the meeting scheduler 204 may include an artificial intelligence engine 210 configured to support the analysis of emails, the scheduling of meetings, and the adjustment (e.g., rescheduling or overbooking) of identified conflicting meetings. The artificial intelligence engine 210 may utilize any type of suitable artificial intelligence including for example, natural language processing, machine learning, deep learning, and/or neural networks. For example, the email analyzer 206 may use the artificial intelligence engine 210 to determine the user preferences and/or user history with direct human interaction. Additionally or alternatively, the meeting analyzer 208 may utilize the artificial intelligence engine 210 to determine whether a conflicting meeting of a participant's digital calendar may be rescheduled or overbooked based on a learned behavior or preference of the particular participant.

Referring now to FIG. 3, in the illustrative embodiment, each user computer device 104 is configured to establish an environment 300 during operation. The illustrative environment 300 includes an email manager 302, a calendar manager 304, and various data sets including, for example, calendar data 320 and user preferences 322. The various components of the environment 300 may be embodied as hardware, firmware, software, or a combination thereof. As such, in some embodiments, one or more of the components of the environment 300 may be embodied as circuitry or a collection of electrical devices (e.g., email manager circuitry 302, calendar manager circuitry 304, etc.) It should be appreciated that, in such embodiments, one or more of those components may form a portion of the processor 152, the I/O subsystem 156, and/or other components of the respective user computer device 104.

The email manager 302 is configured to manage the email communications received from and sent to the calendar scheduling server 102. For example, the email manager 302 may facilitate response to emails from the calendar scheduling server 102 requesting confirmation of a scheduled meeting. Additionally, the email manager 302 may interface with the calendar manager 304 to provide access by calendar scheduling server 102 to the calendar data 320 of the user stored locally on the user computer device 104.

The calendar manager 304 is configured to manage the local digital calendar of the user, which may be stored in the calendar data 320, and/or a remote digital calendar maintained by a third-party service (e.g., a third-party email service). In use, the calendar manager 304 is configured to schedule a meeting on the user's digital calendar based on receipt and acceptance of a meeting invite received from the calendar scheduling server 102. Additionally, the calendar manager 304 may allow the user of the user computer device 104 to manually schedule, remove, and/or adjust digital meetings scheduled on the user's digital calendar. In some embodiments, the calendar manager 304 may be embodied as an application provided and maintained by the calendar scheduling server 102 to facilitate use of the automated scheduling services provided by the calendar scheduling server 102.

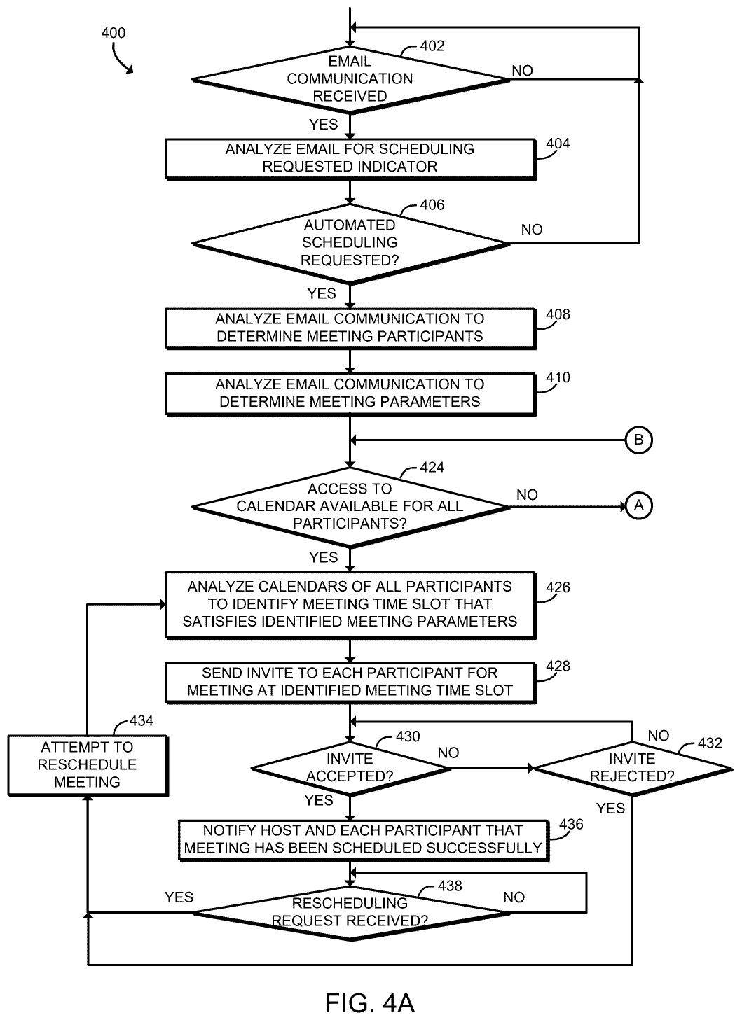

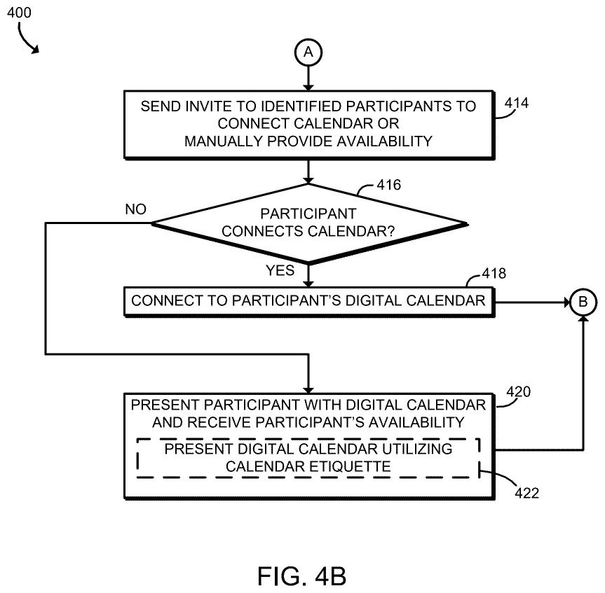

Referring now to FIG. 4, in use, the calendar scheduling server 102 may execute a method 400 for automated scheduling of a meeting. It should be appreciated that, in some embodiments, the operations of the method 400 may be performed by one or more components of the environment 200 of the calendar scheduling server 102 as shown in FIG. 2.

The method 400 begins with block 402, in which the calendar scheduling server 102 determines whether an email communication has been received from one of the user computer device 104 of the system 100. If so, the method 400 advances to block 404 in which the calendar scheduling server 102 analyzes the received email communication to determine whether the email communication includes a scheduling requested indicator that indicates a desire by the sender of the email communication to schedule a meeting. In the illustrative embodiment, the scheduling requested indicator is embodied as a carbon copy of an email address monitored by the calendar scheduling server 102. That is, a user of one of the user computer devices 104 may request the automated scheduling of a meeting by carbon copying the email address monitored by the calendar scheduling server 102. In other embodiments, however, other types of indicators of a desire to schedule a meeting may be used. For example, the email communication may include a direct instruction in the body of the email or the subject line, or the calendar scheduling server 102 may infer the desire to schedule a meeting based on the context of the email itself (e.g., by using natural language processing to understand the context and desire to schedule the meeting from the language used in the email communication).

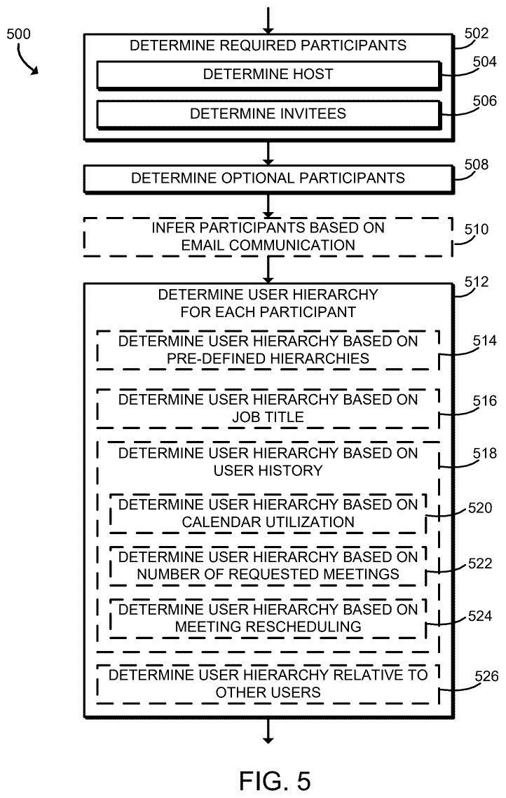

If, in block 406, the calendar scheduling server 102 determines that a request to schedule a meeting was not included in the received email communication, the method 400 loops back to block 402 in which the calendar scheduling server 102 continues to monitor for additional email communications. However, if the calendar scheduling server 102 determines, in block 406, that automated scheduling of a meeting was requested, the method 400 advances to block 408. In block 408, the calendar scheduling server 102 analyzes the email communication to determine the set of participants for the meeting. To do so, the calendar scheduling server 102 may utilize any suitable methodology and associated data. For example, in the illustrative embodiment, the calendar scheduling server 102 executes a method 500 for determining meeting participants as shown in FIG. 5.

The method 500 beings with block 502 in which the calendar scheduling server 102 determines the set of required participants. For example, in block 504, the calendar scheduling server 102 determines the host of the meeting, which is defined as the sender of the email communication including the scheduling requested indicator. Additionally, in block 506, the calendar scheduling server 102 determines additional invitees to the meeting. To do so, the calendar scheduling server 102 may analyze the other recipients of the email communication and determine those recipients are invitees to the requested meeting. Additionally or alternatively, the calendar scheduling server 102 may analyze the email communication to identify any additional participant referenced in the body of the email. For example, the body of the email communication may include a suggestion to invite a particular participant who was not included as a recipient of the email communication. In such embodiments, the calendar scheduling server 102 would determine that the mentioned participant should be designated as an invitee to the requested meeting.

In block 508, the calendar scheduling server 102 also determines any optional participants of the meeting. In some embodiments, the optional participants may be identified in the email communication specifically as optional attendees (e.g., in the recipient header). In other embodiments, the calendar scheduling server 102 may determine optional participants based on an analysis of the body of the email. Additionally, in some embodiments in block 510, the calendar scheduling server 102 may infer participants to be included in the meeting based on the email communication. That is, the calendar scheduling server 102 may be configured to analyze the language of the email communication (e.g., by using the artificial intelligence engine 210) to infer one or more additional participants to invite to the meeting. Such analysis may include a review of user preferences and/or user history. For example, if a particular participant has always been invited to a meeting having the same subject or including the same set of participants, the calendar scheduling server 102 may infer that that participant should be invited to the newly-requested meeting as well. Of course, the calendar scheduling server 102 may be configured to confirm the inferred participants with the host of the meeting prior to including those inferred participants in the scheduled meeting.

Subsequently, in block 512, the calendar scheduling server 102 determines a user hierarchy for each identified participant. To do so, the calendar scheduling server 102 may use any suitable methodology for determining user hierarchies. As discussed above, the user hierarchy provides a relative ranking of “importance” of the participants, which may be used by the calendar scheduling server 102 in subsequent analysis (e.g., when determining whether to reschedule or overbook a meeting). In some embodiments, in block 514, the calendar scheduling server 102 may determine a user hierarchy for each participant based on pre-define hierarchies. For example, the user hierarchy scores may be pre-defined for each user (e.g., assigned at time of employment) and/or maintained over subsequent iterations of the method 400.

Additionally or alternatively, in block 516, the calendar scheduling server 102 may determine a user hierarchy for one or more of the participants based on a job title associated with that respective participant. In such embodiments, for example, the calendar scheduling server 102 may assign a higher user hierarchy for executive-level employees relative to non-executive level employees, a higher user hierarchy to team leads relative to team members, and so forth.

In some embodiments, in block 518, the calendar scheduling server 102 may determine a user hierarchy for one or more of the participants based on a user history associated with that particular participant. In doing so, the calendar scheduling server 102 may be configured to utilize any suitable user-related information. For example, in block 520, the calendar scheduling server 102 may be configured to determine a participant's user hierarchy based on a utilization of the participant's calendar. That is, participants having a larger hourly commitment to meetings (e.g., 40 hours' worth of meeting in a rolling month) may be determined to have a higher user hierarchy than participants having fewer hourly commitments to meetings.

In block 522, the calendar scheduling server 102 may be configured to determine a participant's user hierarchy based the number of requested meetings that participant receives within a defined period time. For example, participants that receive a larger number of meeting requests over a week or month period may be determined to have a higher user hierarchy than participants that receive fewer meeting requests over that same time period.

Additionally, in block 524, the calendar scheduling server 102 may be configured to determine a participant's user hierarchy based on the nature under which meetings are rescheduled based on that participant's availability. For example, if the calendar scheduling server 102 determines meetings are often reschedule if a particular participant cannot attend that meeting, the calendar scheduling server 102 may determine that that particular participant has a relative high user hierarchy. Conversely, if the calendar scheduling server 102 determines meetings typically proceed even if a particular participant cannot attend that meeting, the calendar scheduling server 102 may determine that that particular participant has a relative low user hierarchy.

Furthermore, in some embodiments in block 526, the calendar scheduling server 102 may determine the user hierarchies relative to each other participant. That is, as discussed above, the user hierarchy assigned to each participant by calendar scheduling server 102 may be relative to each other. In this may, each participant may be assigned a pool of different user hierarchies depending on which other participant that particular participant is being compared to.

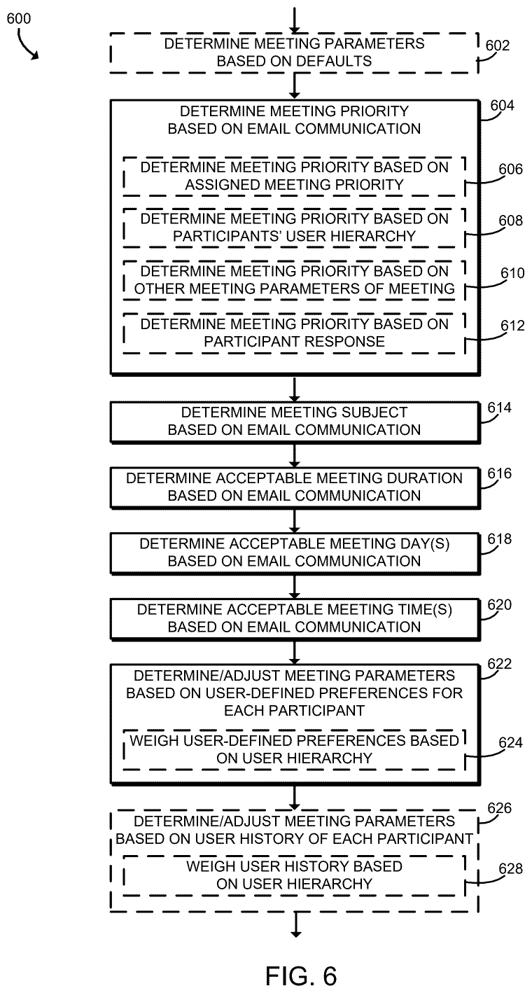

Referring back to FIG. 4, after the calendar scheduling server 102 has determined the meeting participants in block 408, the method 400 advances to block 410 in which the calendar scheduling server 102 analyzes the email communication to determine a set of meeting parameters that the to-be-scheduled meeting should satisfy. The meeting parameters may be embodied as any criteria that defines a characteristic of the requested meeting, such as the meeting hierarchy, the meeting subject, the meeting duration, the meeting day, the meeting time, the maximum time in which the meeting should be scheduled, etc. To determine the meeting parameters, the calendar scheduling server 102 may execute a method 600 for determining meeting parameters as shown in FIG. 6.

The method 600 begins with block 602 in which the calendar scheduling server 102 may, in some embodiments, set the meeting parameters to default meeting parameters. Such default meeting parameters may be globally-defined parameters (e.g., apply to every meeting, be based on a company-wide preference), user-defined parameters (e.g., default parameters that are defined by a particular participant), or other types of default parameters. In the illustrative embodiment, however, the calendar scheduling server 102 is configured to determine or otherwise update one or more meeting parameters based on the email communication itself. For example, the host participant may identify the meeting parameters (e.g., the meeting priority) when sending the email communication. Additionally or alternatively, the calendar scheduling server 102 may analyze the language and/or context of the header and/or body of the email and determine or modify (e.g., if initially based on a default parameter) the meeting parameters.

In block 604, the calendar scheduling server 102 may determine or otherwise modify a meeting priority parameter based on the email communication. For example, in block 606, the calendar scheduling server 102 may determine the meeting priority based on a meeting priority that is assigned by the host participant in the email communication itself (e.g., a “hard coded” meeting priority). That is, the host may flag or otherwise indicate that the requested meeting should be considered of a certain priority. Additionally or alternatively, the calendar scheduling server 102 may infer the meeting priority in block 606 based on the language or context of the email communication (e.g., based on keywords such as “urgent” or “asap” appearing in the email communication).

In some embodiments, in block 608, the calendar scheduling server 102 may determine the meeting priority based on the user hierarchy of one or more identified participants. In doing so, the calendar scheduling server 102 may utilize any suitable methodology for determine the meeting priority based on user hierarchies. For example, the calendar scheduling server 102 may determine the meeting priority based on, or as a function of, the highest user hierarchy score of the participants (e.g., if the requested meeting includes the Chief Executive Officer of a company as a participant, the calendar scheduling server 102 may determine that such a meeting has a high meeting priority). Additionally or alternatively, the calendar scheduling server 102 may determine the meeting priority based on an average hierarchy of the participants, based on the user hierarchy of the identified host, and/or based on another combination of user hierarchies.

Additionally, in some embodiments, the calendar scheduling server 102 may determine the meeting priority based on other meeting parameters in block 610. For example, the meeting priority may be based on the meeting subject (see, e.g., discussion of block 614 below), based on the duration of the requested meeting (see, e.g., discussion of block 616 below), or based on the meeting day/time (see, e.g., discussion of blocks 618 and 620 below). For example, the calendar scheduling server 102 may be configured to determine that requested meetings have a longer duration or requested to occur sooner in time have a higher meeting priority.

In some embodiments in block 612, the calendar scheduling server 102 may additionally or alternatively determine or adjust the meeting priority based on a participant response to the requested meeting. For example, if one or more participants manually adjust their availability or reschedule another meeting to ensure availability for the requested meeting, the calendar scheduling server 102 may determine that the requested meeting is of a higher priority.

In addition to the meeting priority, the calendar scheduling server 102 may be configured to determine or modify other meeting parameters. For example, in block 614, the calendar scheduling server 102 may determine or otherwise modify a meeting subject parameter based on the email communication. To do so, the calendar scheduling server 102 may determine the meeting subject parameter based on the language provided in the subject line of the email commination and/or on context of the body of the email communication. In block 616, the calendar scheduling server 102 may determine or otherwise modify an acceptable meeting duration parameter based on the email communication. Again, the calendar scheduling server 102 may determine the meeting duration parameter based on the language or context of the body of the email communication (e.g., a specific meeting duration may be mentioned in the email or the calendar scheduling server 102 could infer a meeting duration based on the subject of the meeting). In blocks 618 and 620, the calendar scheduling server 102 may determine or otherwise modify an acceptable meeting day(s) and/or time(s) parameters (i.e., an acceptable meeting “timeslot”) based on the email communication. For example, the calendar scheduling server 102 may determine the meeting day and time parameters based on the language or context of the body of the email communication (e.g., a specific day and/or time may be discussed in the email).

In some embodiments, in block 622, the calendar scheduling server 102 may determine or adjust one or more meeting parameters based on user-defined preferences for each participant of the meeting. That is, each participant may specify a set of user preferences that define or otherwise affect one or more meeting parameters. For example, a particular user may specify that he/she is unavailable on a particular day, does not accept meetings before a particular time of the day, can only meet at a certain location, is uninterested in meetings regarding a certain subject, only meets for a defined maximum duration, and so forth. Those user-defined preferences may be stored locally on each participant's user computer device 104 (e.g., in user preferences data 322) and/or by the calendar scheduling server 102 itself (e.g., in the user data 222).

In determining the set of meeting parameters, the calendar scheduling server 102 may collate and consider the user-defined preferences from each participant. It should be appreciated, however, that the collected, global set of user-defined preferences may present scheduling conflicts or otherwise be incompatible with each other. In such situations, the calendar scheduling server 102 may be configured to apply a weight factor to each user-defined preference in block 624. The particular weight factor applied to a particular user-defined preference may vary based on any number and type of criteria. For example, in the illustrative embodiment, the weight factor may be determined based on the relevant user hierarchy. Additionally or alternatively, the weight factor may be determined based on the particular type of user-defined preference (e.g., an availability preference may be weighed more than a duration preference).

In some embodiments, in block 626, the calendar scheduling server 102 may also determine or adjust one or more meeting parameters based on the user history of each participant of the meeting. That is, calendar scheduling server 102 may monitor each participant's interaction with meetings and adjust the meeting parameters based on such interaction history. For example, the calendar scheduling server 102 may determine that a particular participant typically does not accept meetings after a certain time of day or on a certain day and, if so, the calendar scheduling server 102 may update the meeting parameters to ensure the scheduled meeting does not occur after that time of day or on that certain day. The calendar scheduling server 102 may monitor or track user history using the artificial intelligence engine 210 and store the user history data in the user data 222, for example.

Again, in determining the set of meeting parameters, the calendar scheduling server 102 may collate and consider the user histories of each participant. As such, it should be appreciated, that the collected, global set of user histories may present scheduling conflicts or otherwise be incompatible with each other. Similar to the user-defined preferences, the calendar scheduling server 102 may be configured to apply a weight factor to each user history in block 62, which may vary based on any number and type of criteria. For example, in the illustrative embodiment, the weight factor may be determined based on the based on the relevant user hierarchy and/or the freshness of user history (e.g., more recent user activity may be weighed more than old user activity).

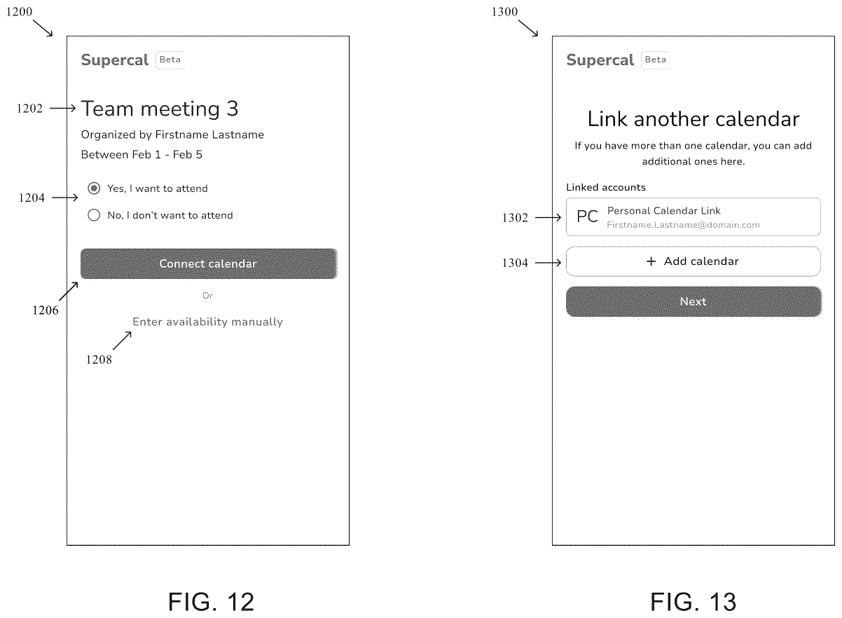

Referring back to FIG. 4, after the calendar scheduling server 102 has determined the meeting parameters in block 410, the method 400 advances to block 412 in which the calendar scheduling server 102 determines whether access to the digital calendar of each meeting participant is available. As discussed above, the digital calendar may be maintained individually by each participant on their respective user computer device 104 or via a third-party application and/or may be maintained by the calendar scheduling server 102 itself. If the calendar scheduling server 102 determines that access to one or more meeting participant's digital calendar is not available, the method 400 advances to block 414 of FIG. 4B in which the calendar scheduling server 102 transmits an invite to the identified participant(s) to either connect or “link” their individual digital calendar to the calendar scheduling server 102 or to manually provide their availability on a digital calendar maintained by the calendar scheduling server 102. For example, as shown in FIG. 12, the calendar scheduling server 102 may present a user interface 1200 to the participant on the participant's user computer device 104. The user interface 1200 includes meeting parameter indicia 1202, which illustratively includes the name or subject matter of the proposed meeting, the name of the host, and a suggested date range for the proposed meeting. The user interface 1200 also includes selection buttons 1204, which the receiving participant can select to provide their intention to attend or not to attend. Additionally, the user interface 1200 includes a selection link 1206 that the participant can select to connect their own digital calendar to the calendar scheduling server 102 and a selection link 1208 that the participant can select to manually supply their availability using a digital calendar maintained by the calendar scheduling server 102 as discussed below.

Referring back to FIG. 4B, if the user determines to connect their own digital calendar in block 416 (e.g., by selection of the selection link 1206), the method 400 advances to block 418 in which the calendar scheduling server 102 connects to the participant's digital calendar. In doing so, the calendar scheduling server 102 may present a user interface 1300 to the participant on the participant's user computer device 104 as shown. As shown in FIG. 13, the illustrative user interface 1300 includes a indicia 1302 of the linked or connected, personal digital calendars of that participant. Additionally, the participant can add additional personally-maintained digital calendar via selection of a link 1304. Once the participant's digital calendar is linked in this manner, the calendar scheduling server 102 can analyze that participant's calendar or calendars as discussed below.

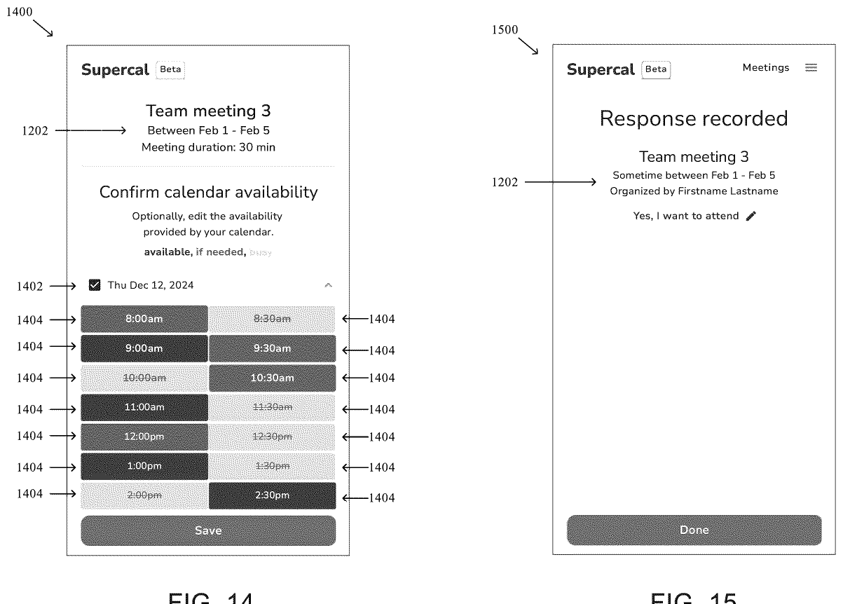

Referring again back to FIG. 4B, if the participant decides not to connect or link their digital calendar to the calendar scheduling server 102 in block 416 (e.g., via selection of selection link 1208), the method 400 advances to block 420. In block 420, the calendar scheduling server 102 presents that participant with a digital calendar that is maintained by the calendar scheduling server 102. The participant may then provide their availability directly on the calendar maintained by the calendar scheduling server 102. For example, as shown in FIG. 14, the calendar scheduling server 102 may present a user interface 1300 to the participant on the participant's user computer device 104, which includes the meeting parameter indicia 1202 that identifies the requested meeting and a digital calendar 1402. As discussed above, the digital calendar 1402 is maintained by the calendar scheduling server 102 and includes a set of time blocks 1404, which the user may select to identify their availability. Each time block 1404 may be color coded or emphasized using another visual mechanism capable of indicating the participant's availability. For example, the participant may select individual time blocks 1404 to identify that they are “available,” “not available,” or “available-if-needed.” In response, the calendar scheduling server 102 may update the background color of each time block 1404. For example, “available” time blocks may be displayed with a green background, “not available” time blocks may be displayed with a red background, and “available-if-needed” may be displayed with a yellow background. It should be appreciated, however, that other coloring schemes may be used in other embodiments.

When initially generating and displaying the digital calendar 1402, the calendar scheduling server 102 may utilize a set of “calendar etiquette” (see, e.g., block 422 of FIG. 4B). The set of “calendar etiquette” may define default parameters of the digital calendar 1402. For example, certain time blocks 1404 may be pre-defined as “available,” “not available,” or “available-if-needed” depending on their particular time coverage, the particular day, user preferences, user hierarchy, user history, meeting priority, etc. For example, in an illustrative embodiment, the calendar scheduling server 102 may identify time blocks 1404 occurring before or after a certain time period (e.g., before 8 AM or after 6 PM on a weekday and all day on a weekend) as “not available” or “available-if-needed,” so as to acknowledge the typical workday of a participant. Additionally, the calendar scheduling server 102 may identify time blocks 1404 that occur immediately before or after a “not available” time block as “available-if-needed” to provide the participant time before or between meetings to prepare and/or attend to other activities (rather than moving from one meeting directly to the next meeting). The remaining time blocks 1404 may be initially marked as “available’ (e.g., colored green) by the calendar scheduling server 102. Again, it should be appreciated that the availability initially identified by the calendar scheduling server 102 in each time block 1404 may be modified by the particular participant. For example, although the calendar scheduling server 102 may mark a time block 1404 covering 6 AM as “not available,” the participant may manually update that time block 1404 to show as “available” or “available-if-needed,” based on that participant's availability. The participant may also update time blocks 1404 initially identified as “available” with “not available” or “available-if-needed,” if that participant has another meeting or task to attend to or is otherwise not available during that corresponding time frame. In this way, the calendar scheduling server 102 facilitates the manual entry of a participant's availability without the requirement of a direct connection or link to a personal digital calendar maintained by the participant.

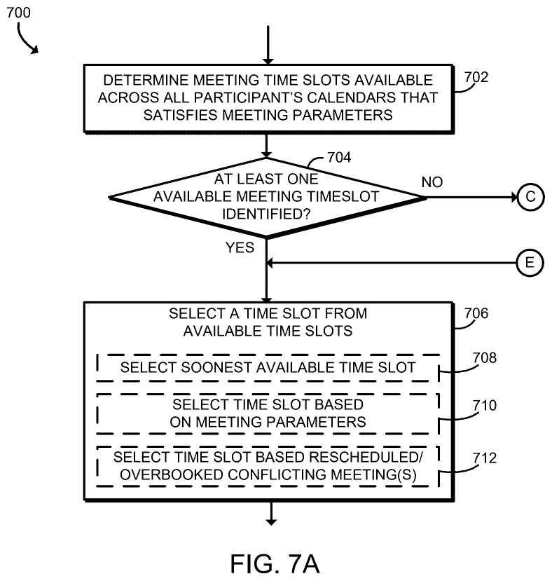

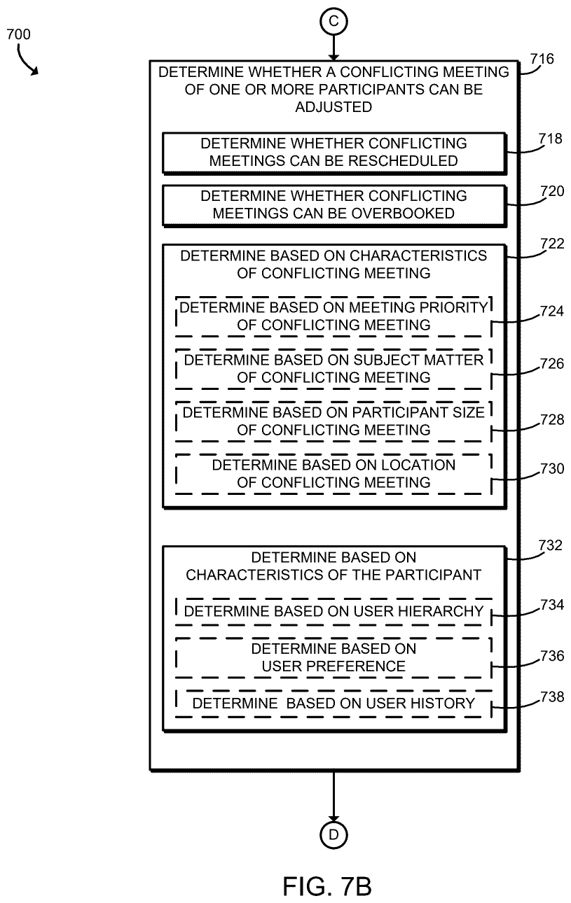

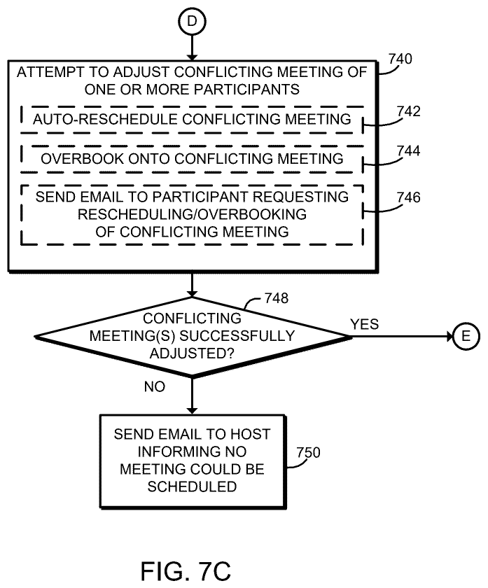

Regardless whether the participant opts to connect their digital calendar or provides their availability on the digital calendar maintained by the calendar scheduling server 102, the calendar scheduling server 102 may provide a notification to the participant that their availability response (either manually provided or inferred from their digital calendar) has been received. For example, as shown in FIG. 15, the calendar scheduling server 102 may present a user interface 1500 to the participant on the participant's user computer device 104. The user interface 1500 includes the meeting parameter indicia 1202 that identifies the requested meeting and confirms receipt of that participant's availability. The method 400 subsequently loops back to block 424 of FIG. 4A. In block 424, the calendar scheduling server 102 determines whether a digital calendar for each participant is available (i.e., either the participant's own digital calendar or a digital calendar maintained by the calendar scheduling server 102). If so, the method 400 advances to block 426 in which the calendar scheduling server 102 analyzes the digital calendars of each meeting participant to identify or determine a meeting time slot (i.e., a meeting day, time, and duration) that satisfies the identified meeting parameters. To do so, the calendar scheduling server 102 may execute a method 700 for determining an available meeting time slot for each meeting participant as shown in FIGS. 7A-7C.

The method 700 begins with block 702 in which the calendar scheduling server 102 determines the global set of meeting time slots that are available across all of the participant's digital calendar and which satisfy the meeting parameters. That is, the calendar scheduling server 102 analyzes the digital calendars of each meeting participant to identify one or more time slots available in each calendar that also satisfies the determined meeting parameters. In bock 704, the calendar scheduling server 102 determines if at least one time slot across the digital calendars of all identified participants was successfully identified. If so, the method advances to block 706.

In block 706, the calendar scheduling server 102 selects a time slot in which to schedule the meeting from the available identified in block 702. If more than one time slot is available for selection, the calendar scheduling server 102 may utilize any suitable methodology to select the time slot from those that are available. For example, in some embodiments in block 708, the calendar scheduling server 102 may select the time slot that is the soonest in time from the present day. Alternatively, in block 710, the calendar scheduling server 102 may select the time slot that best satisfies the meeting parameters. For example, the calendar scheduling server 102 may select the time slot that satisfies the most meeting parameters or the time slot that satisfies the meeting parameters to the greatest degree. Additionally, in some embodiments in block 712, the calendar scheduling server 102 may select the time slot that requires the least number or degree of rescheduling or overbooking of conflicting meetings as discussed in more detail below.

Referring back to block 704, if the calendar scheduling server 102 is unable to identify at least one time slot available in each participant's calendar that also satisfies the determined meeting parameters, the method 700 advances to block 716 of FIG. 7B. In block 716, the calendar scheduling server 102 determines whether a conflicting meeting identified on the digital calendar of one or more participants can be adjusted. That is, the inability of the calendar scheduling server 102 to determine at least one available time slot across the participant's calendars is typically due to one or more conflicting meetings. As such, in block 718, the calendar scheduling server 102 may determine whether each conflicting meeting can be rescheduled on that particular participant's digital calendar. The rescheduling of a conflicting meeting involves moving the conflicting meeting to a different time slot on that participant's calendar (and on the corresponding digital calendar of any additional participants of that conflicting meeting). For example, the conflicting meeting may be moved to a different time and/or day.

Additionally or alternatively, in block 720, the calendar scheduling server 102 may determine whether each conflicting meeting can be overbook on that particular participant's digital calendar. The overbooking of a conflicting meeting involves scheduling the requested meeting during at least a portion of the day and time at which the conflicting meeting occurs such that the two meeting overlap to some degree. It should be appreciated that the calendar scheduling server 102 may first attempt to reschedule a conflicting meeting and then attempt to overbook that conflicting meeting if the calendar scheduling server 102 is unable to reschedule it or vice versa.

The calendar scheduling server 102 may utilize any suitable methodology to attempt to reschedule or overbook a conflicting meeting on a participant's digital calendar. In some embodiments, the calendar scheduling server 102 may attempt to reschedule or overbook a conflicting meeting based on characteristics of the conflicting meeting in block 722. In doing so, the calendar scheduling server 102 may consider any type of characteristic of the conflicting meeting. For example, in block 724, the calendar scheduling server 102 may determine whether a conflicting meeting can be rescheduled or overbooked based on the meeting priority of the conflicting meeting. For example, the calendar scheduling server 102 may determine that the conflicting meeting can be rescheduled if the conflicting meeting has a relative low meeting priority. Alternatively, in some embodiments, the calendar scheduling server 102 may be configured to compare the meeting priority of the conflicting meeting to the meeting priority of the requested meeting to determine whether the conflicting meeting can be rescheduled or overbooked. In such embodiments, the calendar scheduling server 102 may determine that the conflicting meeting can be rescheduled or overbook if the conflicting meeting has a lower meeting priority relative to the meeting priority of the requested meeting.

Additionally or alternatively, in block 726, the calendar scheduling server 102 may determine whether a conflicting meeting can be rescheduled or overbooked based on a subject matter of the conflicting meeting (e.g., a conflicting meeting deemed to be of less importance, such as a status update meeting, may be determined to be available for rescheduling or overbooking). Additionally, in some embodiments in block 728, the calendar scheduling server 102 may determine whether a conflicting meeting can be rescheduled or overbooked based on the participant size of the conflicting meeting (e.g., a conflicting one-on-one meeting may be deemed to be available or otherwise easier to reschedule or overbook). Further, in some embodiments in block 730, the calendar scheduling server 102 may determine whether a conflicting meeting can be rescheduled or overbooked based on the location of the conflicting meeting (e.g., a local meeting may be deemed be available or otherwise easier to reschedule or overbook).

Additionally or alternatively, the calendar scheduling server 102 may attempt to reschedule or overbook a conflicting meeting based on characteristics of the participant having the conflicting meeting in block 732. In doing so, the calendar scheduling server 102 may consider any type of suitable characteristic of that participant. For example, in block 734, the calendar scheduling server 102 may determine whether a conflicting meeting can be rescheduled or overbooked based on the user hierarchy of the participant having the conflicting meeting. In doing so, the calendar scheduling server 102 may, for example, determine that the conflicting meeting can be rescheduled or overbooked if the user hierarchy of the participant having the conflicting meeting is less than the average user hierarchy of the rest of the participants or is less than the highest hierarchy of the rest of the participants.

Additionally, in some embodiments in block 736, the calendar scheduling server 102 may determine whether a conflicting meeting can be rescheduled or overbooked based on a user preference of the participant having the conflicting meeting. That is, the participant may define which types of meetings may be rescheduled or overbooked (e.g., the participant may have a preference that meetings having certain characteristics may or may not be rescheduled or overbooked). Additionally or alternatively, in block 738, the calendar scheduling server 102 may determine whether a conflicting meeting can be rescheduled or overbooked based on the user history of the participant having the conflicting meeting. For example, if the user has a tendency to accept the rescheduling or overbooking of certain types of conflicting meetings or does not attend certain types of conflicting meetings, the calendar scheduling server 102 may determine those types of conflicting meetings may be rescheduled or overbooked.

After the calendar scheduling server 102 has determined whether each identified conflicting meeting of the one or more participants is available for rescheduling or overbooking in block 716, the method 700 advances to block 740 of FIG. 7C. In block 740, the calendar scheduling server 102 attempts to adjust each conflicting meeting. For example, in block 742, the calendar scheduling server 102 may attempt to auto-reschedule the conflicting meeting by determining a new time slot for that conflicting meeting on the participant's digital calendar (and any other participants of that conflicting meeting). The calendar scheduling server 102 may use the methodologies disclosed herein to determine the new time slot for the rescheduled conflicting meeting. Alternatively, in block 744, the calendar scheduling server 102 may overbook the conflicting meeting by “ignoring” the conflicting meeting and scheduling the requested meeting over at least a portion of that conflicting meeting.

It should be appreciated that, in some embodiments, the rescheduling and overbooking of the conflicting meeting(s) is performed by the calendar scheduling server 102 in an autonomous manner. Alternatively, in some embodiments in block 746, the calendar scheduling server 102 may send an email to each participant having a rescheduled/overbooked conflicting meeting to confirm the acceptability of the proposed rescheduling/overbooking. Regardless, in block 748, the calendar scheduling server 102 determines whether the conflicting meeting(s) were successfully adjusted (e.g., accepted by the affected participant). If not, in block 750, the calendar scheduling server 102 sends an email to the host of the requested meeting that the requested new meeting could not be scheduled based on the determined meeting parameters and participants. In response, the host may manually update the meeting parameters and/or participants and request the calendar scheduling server 102 to attempt to schedule the meeting again or manually schedule the meeting themselves.

However, if the calendar scheduling server 102 is successful in rescheduling or overbooking the conflicting meeting(s), the method 700 loops back to bock 706 of FIG. 7A. As discussed above, in block 706, the calendar scheduling server 102 selects a time slot in which to schedule the meeting from the available time slots, which may now be available due to the rescheduling/overbooking of one or more conflicting meetings.

Referring now back to FIG. 4, after the calendar scheduling server 102 has identified the meeting time slot in which to schedule the requested meeting in block 426, the method 400 advances to block 428. In block 428, the calendar scheduling server 102 sends a meeting invite to each meeting participant for the identified meeting time slot. In block 430, the calendar scheduling server 102 determines whether each invite has been accepted. If not, the method 400 advances to block 432 in which the calendar scheduling server 102 determines whether any participant has rejected an invite. If so, the method 400 advances to block 434 in which the calendar scheduling server 102 attempts to reschedule the requested meeting to a different time slot using the methodologies discussed above. In doing so, the host participant may be notified and may update or modify certain meeting parameters (e.g., the acceptable time range, duration, time of day, etc.). In some embodiments, the calendar scheduling server 102 may provide suggestions or otherwise identify time slots that best satisfy the meeting parameters, includes the greatest number of available participants, requires the least number of rescheduling/overbooking, etc.

If, however, the calendar scheduling server 102 determines that all participants have been accepted in block 430, the method 400 advances to block 436. In block 436, the calendar scheduling server 102 sends an email to the host and each invitee to notify them that the requested meeting has been successfully scheduled and provides details of that scheduled meeting. The calendar scheduling server 102 may then monitor for any rescheduling requests received from any participant of the meeting in block 438. If the calendar scheduling server 102 receives a request to reschedule the scheduled meeting, the method 700 advances to block 434 in which the calendar scheduling server 102 attempts to reschedule the requested meeting to a different time slot using the methodologies discussed above. In this way, the calendar scheduling server 102 is configured to provide automated scheduling of meetings to participants upon request.

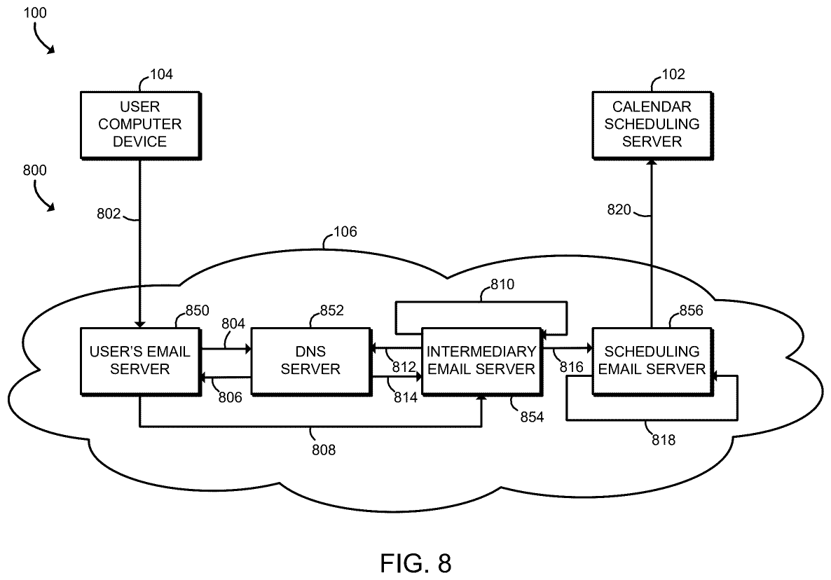

Referring now to FIG. 8, a process flow 800 illustrates an embodiment of the flow of an email communication from one of the user computer devices 104 (e.g., a “host” user computer device 104) to the calendar scheduling server 102 through various intermediary servers located in the network 106. The process flow begins with process 802 in which the user computer device 104 sends an email with the calendar scheduling server 102 identified as one of the recipients (e.g., as a carbon copy or blind carbon copy recipient). In the illustrative embodiment, the email communication is received by the user's Simple Mail Transfer Protocol (SMTP) email sever 850, which is located in the network 106. In response, in process 804, the user's email server 850 queries a Domain Name Server (DNS) 852 for a Mail Exchange (MX) record that provides a connection path to the calendar scheduling server 102. The DNS 852 responds in process 806 with the requested MX record for the calendar scheduling server 102. The user's email server 850 analyzes the received MX record to determine the connection path and connects to an intermediary email server 854 in process 808 to forward along the email communication with a forwarding rule appended to the email communication, which directs the email communication to the calendar scheduling server 102. In process 810, the intermediary email server 854 analyzes the forwarding rule to determine the next connection in the email forwarding path and, in process 812, the intermediary email server 854 queries the DNS 852 for the MX record that provides a connection path to the SMTP email server 856 of the calendar scheduling server 102. The DNS 852 responds in process 814 with the requested MX record for the calendar scheduling server 102. The intermediary email server 854 analyzes the received MX record to determine the connection path and connects to the scheduling SMTP email server 856 in process 816 to forward along the email communication. In process 818, the scheduling SMTP email server 856 receives and processes the email communication to determine the recipient, which is the calendar scheduling server 102. As such, in process 820, the scheduling SMTP email server 856 forwards the email communication to the scheduling server 102 for processing using the methodologies described above. It should be appreciated that while a single intermediary email server 854 is shown in FIG. 8, the process flow may flow through additional intermediary email servers in other embodiments.

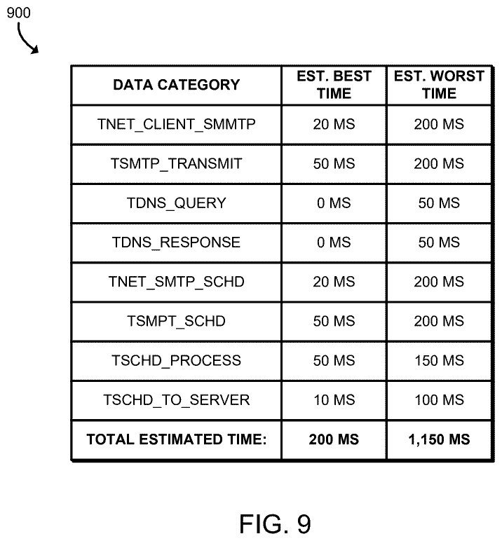

It should be appreciated that the system 100 effects the scheduling of a 1:1 or 1:Many meeting with increased speed and efficiency relative to typical ad hoc scheduling processes. For example, in the illustrative embodiment, the email propagation from the user computer device 104 to the calendar scheduling server 102 illustrated in FIG. 8 is estimated to complete within 200 to 1,150 milliseconds, which can facilitate the scheduling of a meeting in “real time” or “near real time.” For example, as table 900 of estimated best and worst times for completion of processes of the process flow 800 is shown in FIG. 9. As provided, the time required for the user computer device 104 to connect to the user's email server 850 (“Tnet_client_smtp”) is estimated to take from 20 milliseconds to 200 milliseconds. Additionally, the time required for the user computer 104 to handshake with the user's email server 850 and transmit the email communication (“Tsmtp_transmit”) is estimated to take from 50 milliseconds to 200 milliseconds.

The time required for the user's email server 850 to query the DNS server 852 for the MX records of the domain of the calendar scheduling server 102 (“Tdns_query”) is estimated to take from less than one milliseconds to 50 milliseconds, and the time required for the DNS server 852 to respond with the requested MX records (“Tdns_response”) is estimated to take from less than one milliseconds to 50 milliseconds.

Furthermore, the time required for the intermediary email server 854 to connect with the email communication to the scheduling email server 856 (“Tnet_smtp_schd”) is estimated to take from is estimated to take from 20 milliseconds to 200 milliseconds. The time required for the intermediary email server 854 to handshake with the scheduling email server 856 and transmit the email communication (“Tsmtp_schd”) is estimated to take from 50 milliseconds to 200 milliseconds. Additionally, the time required from the scheduling email server 856 to receive and process (e.g., filter) the email communication received from the intermediary email server 854 is estimated to take from 50 milliseconds to 150 milliseconds. And, the time required for the scheduling email server 856 to forward the email communication (or its metadata) to the calendar scheduling server 102 is estimated take 10 milliseconds to 100 milliseconds. In this way, the user computer device 104 is configured to communicate the email communication to the calendar scheduling server 102 in the estimated time frame of 200 milliseconds to 1,150 milliseconds, which supports the scheduling of meetings in “real time” or “near real time.”

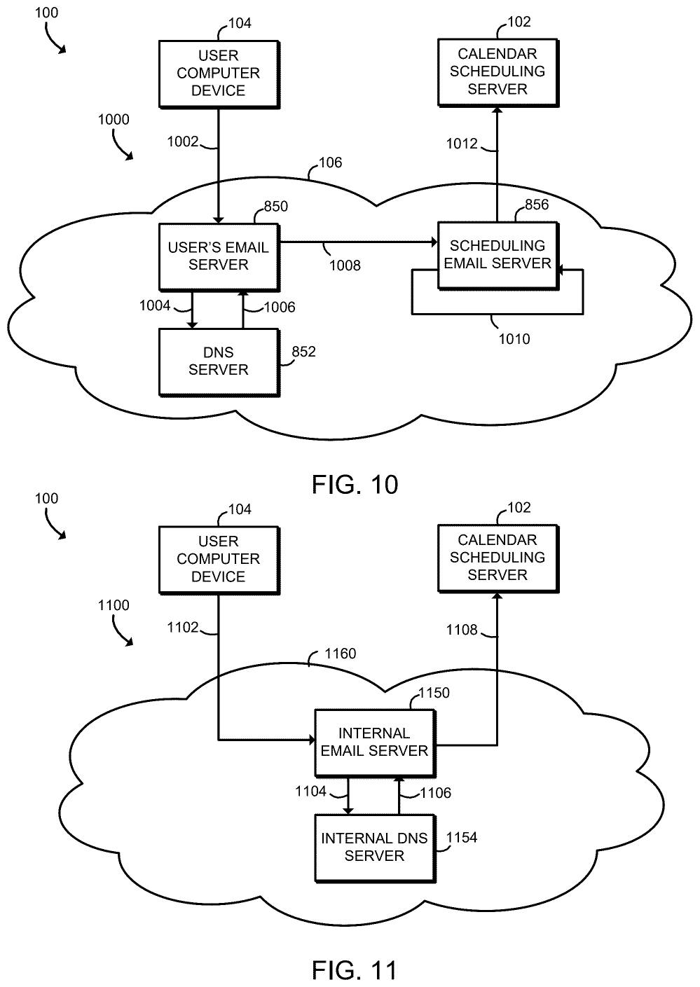

It should be appreciated that, in some embodiments, the calendar scheduling server 102 may be embodied as a dedicated server to, for example, a single enterprise. In such embodiments, the process flow may flow directly from the user's email server 850 to the scheduling email server 856 without the requirement of any intermediary email servers 854. For example, as shown in FIG. 10, a process flow 1000 illustrates an embodiment of the flow of an email communication from one of the user computer devices 104 (e.g., a “host” user computer device 104) to the calendar scheduling server 102 through a dedicated scheduling email server 856 located in the network 106. The process flow begins with process 1002 in which the user computer device 104 sends an email with the calendar scheduling server 102 identified as one of the recipients (e.g., as a carbon copy or blind carbon copy recipient). In the illustrative embodiment, the email communication is received by the user's SMTP email sever 850. In response, in process 1004, the user's email server 850 queries the DNS 852 (e.g., a dedicated DNS) for an MX record that provides a connection path to the calendar scheduling server 102. The DNS 852 responds in process 1006 with the requested MX record for the calendar scheduling server 102. The user's email server 850 analyzes the received MX record to determine the connection path and connects to the scheduling SMTP email server 856 in process 1008 to forward along the email communication. In process 1010, the scheduling SMTP email server 856 receives and processes the email communication to determine the recipient, which is the calendar scheduling server 102. As such, in process 1012, the scheduling SMTP email server 856 forwards the email communication to the scheduling server 102 for processing using the methodologies described above.

In yet other embodiments, the calendar scheduling server 102 may be embodied as a local scheduling server dedicated to a single enterprise. In such embodiments, as shown in FIG. 11, an internal email server 1150 and internal DNS server 1154 are located in an internal network 1160, which may or may not have access to outside networks such as the Internet. In this way, the calendar scheduling server 102 may be embodied as a single enterprise scheduling solution configured to internal meeting scheduling. In such embodiments, a process flow 1100 begins with process 1102 in which the user computer device 104 sends an email with the calendar scheduling server 102 identified as one of the recipients (e.g., as a carbon copy or blind carbon copy recipient). In the illustrative embodiment, the email communication is received by the internal email server 1150. In response, in process 1104, the internal email server 1150 queries an internal DNS server 1154 for an MX record that provides a connection path to the calendar scheduling server 102. The DNS server 1154 responds in process 1106 with the requested MX record for the calendar scheduling server 102. The internal email server 1150 processes the email communication to determine the recipient, which is the calendar scheduling server 102. As such, in process 1108, the internal email server 1150 forwards the email communication to the scheduling server 102 for processing using the methodologies described above.

While the disclosure has been illustrated and described in detail in the drawings and foregoing description, such an illustration and description is to be considered as illustrative and not restrictive in character, it being understood that only illustrative embodiments have been shown and described and that all changes and modifications that come within the spirit of the disclosure are desired to be protected.

There are a plurality of advantages of the present disclosure arising from the various features of the methods, apparatuses, and systems described herein. It will be noted that alternative embodiments of the methods, apparatuses, and systems of the present disclosure may not include all of the features described yet still benefit from at least some of the advantages of such features. Those of ordinary skill in the art may readily devise their own implementations of the methods, apparatuses, and systems that incorporate one or more of the features of the present invention and fall within the spirit and scope of the present disclosure as defined by the appended claims.

1. A method for automated scheduling of a meeting, the method comprising:
receiving, by a server computer, an email communication from a sender;
determining, by the server computer, whether to schedule the meeting based on whether the email communication includes an indicator that indicates a desire by the sender to schedule the meeting;
analyzing, by the server computer and in response to a determination to schedule the meeting, the email communication to determine a set of participants for the meeting, wherein the set of participants includes a host identified as the sender of the email communication and at least one invitee;
analyzing, by the server computer and in response to the determination to schedule the meeting, the email communication to determine a set of meeting parameters, wherein the set of meeting parameters define characteristics of the meeting;
analyzing, by the server computer, a digital calendar of each participant of the set of participants to identify a time slot that satisfies the set of meeting parameters; and
scheduling, by the server computer, the meeting on the digital calendar of each participant of the set of participants at the identified time slot.

2. The method of claim 1, wherein determining whether to schedule the meeting comprises determining whether a reference email address is included in the email communication.

3. The method of claim 1, wherein analyzing the email communication to determine a set of participants for the meeting comprises determining each recipient of the email communication.

4. The method of claim 1, wherein analyzing the email communication to determine a set of participants for the meeting comprises analyzing the email to determine a participant of the meeting that is (i) mentioned in the email communication and (ii) not a recipient of the email communication.

5. The method of claim 1, wherein analyzing the email communication to determine the set of meeting parameters comprises setting each meeting parameter of the set of meeting parameters to a default parameter.

6. The method of claim 1, wherein analyzing the email communication to determine the set of meeting parameters comprises analyzing the email communication to determine a meeting subject, a meeting duration, a meeting date, or a meeting time for the meeting.

7. The method of claim 1, wherein analyzing the email communication to determine the set of meeting parameters comprises determining at least one meeting parameter of the set of meeting parameters based on a user-defined preference of a participant of the set of participants of the meeting.

8. The method of claim 1, wherein analyzing the email communication to determine the set of meeting parameters comprises determining at least one meeting parameter of the set of meeting parameters based on a user history of a participant of the set of participants of the meeting.

9. The method of claim 1, wherein analyzing the digital calendar of each participant of the set of participants to identify the time slot that satisfies the set of meeting parameters comprises:
identifying, by the server computer, a conflicting meeting of at least one participant of the set of participants that conflicts with the identified time slot;
determining, by the server computer, whether the conflicting meeting can be rescheduled; and
adjusting, by the server computer, the conflicting meeting on the digital calendar of the at least one participant to a different time slot than the identified time slot.

10. The method of claim 9, wherein determining whether the conflicting meeting can be rescheduled comprises determining whether the conflicting meeting can be rescheduled based on a characteristic of the conflicting meeting.

11. The method of claim 10, wherein the characteristic of the conflicting meeting includes at least one of a subject matter of the conflicting meeting, a number of participants of the conflicting meeting, and a location of the conflicting meeting.

12. The method of claim 9, wherein determining whether the conflicting meeting can be rescheduled comprises determining whether the conflicting meeting can be rescheduled based on a characteristic of the least one participant of the set of participants.

13. The method of claim 12, wherein the characteristic of the least one participant of the set of participants includes a user preference, a user history, or a user hierarchy of the least one participant of the set of participants.

14. A server computer for automated scheduling of a meeting, the server computer comprising:
a processor; and
a memory having stored therein a plurality of instructions that, when executed by the processor, cause the server computer to:
determine whether to schedule the meeting based on whether an email communication received by the server computer and from a sender includes an indicator that indicates a desire by the sender to schedule the meeting;
analyze, in response to a determination to schedule the meeting, the email communication to determine a set of participants for the meeting, wherein the set of participants includes a host identified as the sender of the email communication and at least one invitee;
analyze, in response to the determination to schedule the meeting, the email communication to determine a set of meeting parameters, wherein the set of meeting parameters define characteristics of the meeting;
analyze a digital calendar of each participant of the set of participants to identify a time slot that satisfies the set of meeting parameters; and
schedule the meeting on the digital calendar of each participant of the set of participants at the identified time slot.

15. The server computer of claim 14, wherein to analyze the digital calendar of each participant of the set of participants to identify the time slot that satisfies the set of meeting parameters comprises to:
identify a conflicting meeting of at least one participant of the set of participants that conflicts with the identified time slot;
determine whether the conflicting meeting can be rescheduled; and
adjust the conflicting meeting on the digital calendar of the at least one participant to a different time slot than the identified time slot.

16. The method of claim 15, wherein to determine whether the conflicting meeting can be rescheduled comprises to determine whether the conflicting meeting can be rescheduled based on a characteristic of the conflicting meeting.

17. The method of claim 15, wherein to determine whether the conflicting meeting can be rescheduled comprises to determine whether the conflicting meeting can be rescheduled based on a characteristic of the least one participant of the set of participants.

18. One or more non-transitory, computer-readable storage media comprising a plurality of instructions that, in response to execution, cause a server computer to:
determine whether to schedule the meeting based on whether an email communication received by the server computer and from a sender includes an indicator that indicates a desire by the sender to schedule the meeting;
analyze, in response to a determination to schedule the meeting, the email communication to determine a set of participants for the meeting, wherein the set of participants includes a host identified as the sender of the email communication and at least one invitee;
analyze, in response to the determination to schedule the meeting, the email communication to determine a set of meeting parameters, wherein the set of meeting parameters define characteristics of the meeting;
analyze a digital calendar of each participant of the set of participants to identify a time slot that satisfies the set of meeting parameters; and
schedule the meeting on the digital calendar of each participant of the set of participants at the identified time slot.

19. The one or more non-transitory, computer-readable storage media of claim 18, wherein to analyze the digital calendar of each participant of the set of participants to identify the time slot that satisfies the set of meeting parameters comprises to:
identify a conflicting meeting of at least one participant of the set of participants that conflicts with the identified time slot;
determine whether the conflicting meeting can be rescheduled; and
adjust the conflicting meeting on the digital calendar of the at least one participant to a different time slot than the identified time slot.

20. The method of claim 19, wherein to determine whether the conflicting meeting can be rescheduled comprises to determine (i) whether the conflicting meeting can be rescheduled based on (i) a characteristic of the conflicting meeting or (ii) a characteristic of the least one participant of the set of participants.
